(19) United States
(12) Patent Application Publication
(10) Pub. No.: US 2007/0268154 A1
(43) Pub. Date: Nov. 22, 2007

(54) Measure acquisition system

(75) Inventors: Roberto BOCCELLATO, Seriate (BG) (IT); Frank Eduardo Lima LOBATO, Sao Paulo (BR)

Correspondence Address: MERCHANT & GOULD PC, P.O. BOX 2903, MINNEAPOLIS, MN, 55402-0903, US

(73) Assignee: M.Shimizu Eletrica E Pneumatica Ltda, Sao Paulo (BR)

(21) Appl. No.: 11/805,467

(22) Filed: May 22, 2007

(30) Foreign Application Priority Data
May 22, 2006 (BR) PI 0603345-8

(51) Int. Cl. G08C 17/02

(52) U.S. Cl. 340/870.28

(57) ABSTRACT

The present invention relates to a measure acquisition system (300) comprising a measure acquisition assembly (200), which comprises a casing (30) being enclosed by a cover (40), an electronic card (50) coupled to said cover (40), a power supply (20) supplying power to said electronic card (50), and a transducer (10) connected to said electronic card (50); a receiver means (11) that communicates with the measure acquisition assembly (200) by means of radiofrequency, and alternatively an antenna (21), which receives information from the receiver means (11) and transfers the same to a base station (31).

### FIELD OF THE INVENTION

The present invention relates to a measure acquisition system and, more particularly, to a measure acquisition system without the use of cables.

### BACKGROUND OF THE INVENTION

A number of measure acquisition systems are commercially available. The differences between such measure acquisition systems and the present invention system lie in the use of components widely spread on the market, rather than the proprietary components utilized by the current systems, which makes easier their assembly and maintenance, as well as the system mobility, due to the non-use of cables and the possibility of storing data acquired in the system itself.

The demand for a measure acquisition system of easy construction and use, as well as of a reduced cost, has been growing gradually on the consumer market. Examples of measure acquisition systems are described in European patents EP 1 068 931 and 1 439 035 and in U.S. Pat. No. 5,533,409.

The European patent EP 1 068 931 illustrates a measurement assembly including a tool having a micro-processed unity and a transponder that measure and manage the data and next communicate with a monitoring station. The fact that this document utilizes a transponder to transmit the data entails the drawback of the system being highly affected by metallic bodies, which would be extremely disastrous where an automotive production line is involved. Additionally, the transponder requires an antenna for each position to be monitored, and the tuning of such antennas is too problematic. Eventually, the communicational speed using a transponder is very low.

European patent EP 1 439 035 describes a signal control and processing device that can be detachably engaged in a tool, said device processing signals representative of pulses from a torque sensor. In this case, device supply depends on the power supply of the tool the device is coupled to. Briefly, the patent describes a torque transducer based on the measurement of a magnetic field distortion proportional to the torque. The output of this device is an analog signal that needs to be processed by a smart receiver so as to obtain the torque value.

U.S. Pat. No. 5,533,409 illustrates an apparatus for providing information on the angular motion and torque applied to a threaded element comprising a sensor that provides a pulse output and a microprocessor that monitors the output to provide angular motion information of a torque key. In addition, a memory is envisaged for keeping the monitored information.

### SUMMARY OF THE INVENTION

The present invention is directed to a measure acquisition system that can be coupled to any measuring tool, for example, to estimate a torque applied to screws in assembly lines. The systems envisages the use of a memory card having a transducer that sends the measured data to a receiver without using cables/wires, that is, data are processed and digitalized for their respective sending.

An objective of the present invention is to provide a wireless measure acquisition system, which facilitates the tool operator mobility in any industrial environment. Additionally, the system has a receiver able to collect data from various transmitting tools, taking into account the technology utilized to this end.

Another objective of the present invention is to provide a measure acquisition system that will store and process the data estimated during the measurement in the location where the system is used, facilitating and speeding up the analysis of the data received from the acquisition system, so as to optimize the making of decisions and the reduction of the processing costs, giving the solution more integrity.

Another advantageous objective of the present invention is to provide elements easily found on the market, rather than proprietary elements, which renders the system modular and makes possible the production and maintenance of the system in an easier manner and at a lower cost.

Finally, another objective of the present invention is to provide a system that will communicate the data read by the acquisition system in a quick and reliable way.

The objectives of the present invention are achieved with the provision of a measure acquisition system comprising a measure acquisition assembly that has a casing enclosed by a cover, an electronic card coupled to said cover, a power supply supplying power to said electronic card; a transducer connected to the said electronic card of the measure acquisition assembly; and a receiver means communicating with the measure acquisition assembly by means of radiofrequency.

### BRIEF DESCRIPTION OF THE DRAWINGS

The present invention will be better understood based on the following detailed description when taken in conjunction with the appended drawings, in which:

FIGS. 1 through 4 are perspective views of the present invention measure acquisition system as applied to a torque key, in its disassembled form;

FIG. 5 is a side view of the present invention measure acquisition system as applied to a torque key, as illustrated in FIGS. 1 through 4;

FIG. 6 illustrates the measure acquisition system comprising the acquisition assembly, the receiver means and the base station;

FIGS. 7 and 11 are front perspective views of the present invention measure acquisition assembly, in its disassembled form;

FIG. 8 is a rear perspective view of the present invention measure acquisition assembly, in its assembled form;

FIGS. 9 and 10 are rear perspective views of the present invention measure acquisition assembly, in its disassembled form;

FIG. 12 illustrates the operation of the present invention measure acquisition system; and

FIGS. 13 through 19 illustrate displays of the software associated with the measure acquisition system, object of the present invention.

### DETAILED DESCRIPTION OF THE PREFERRED EMBODIMENT

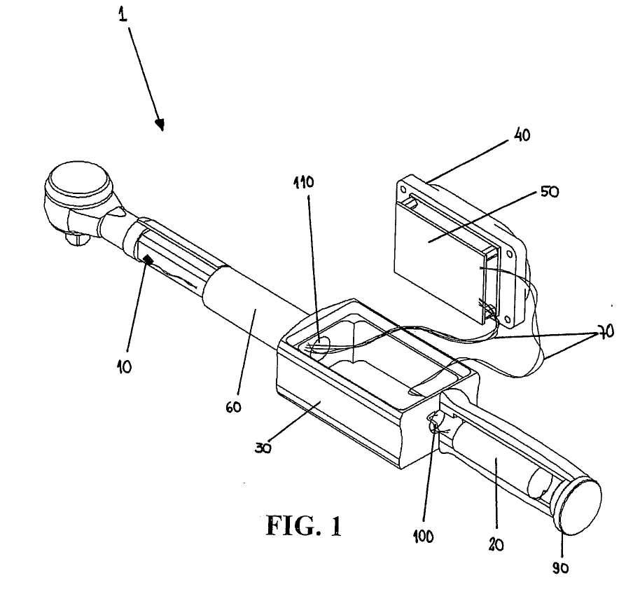

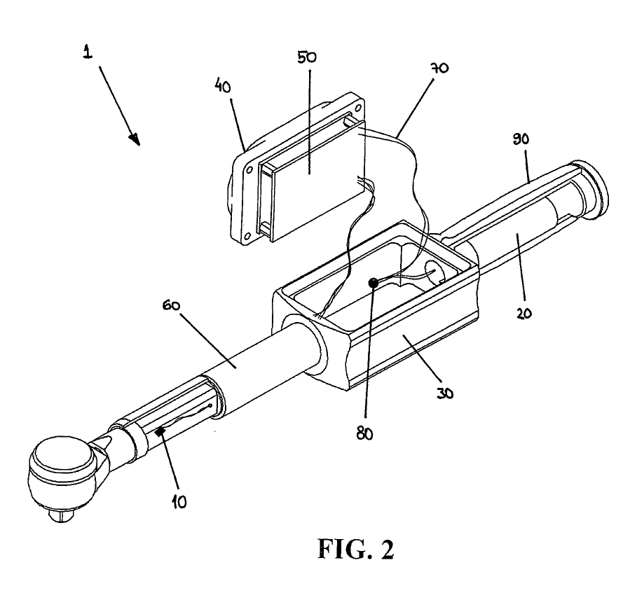

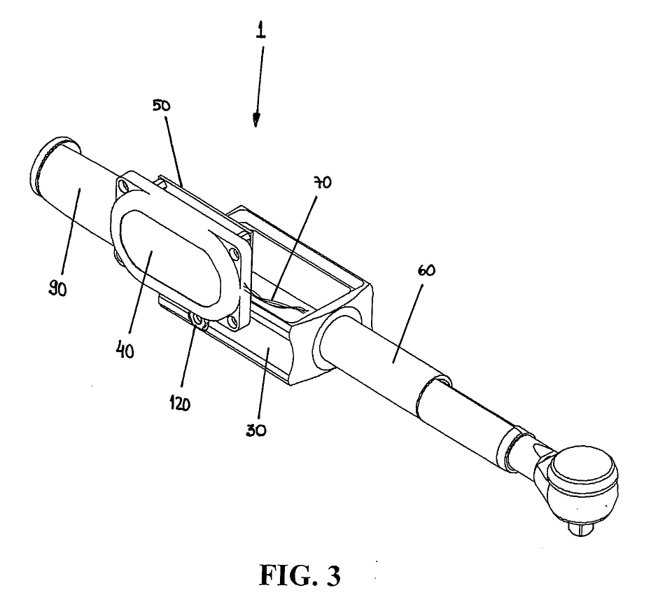

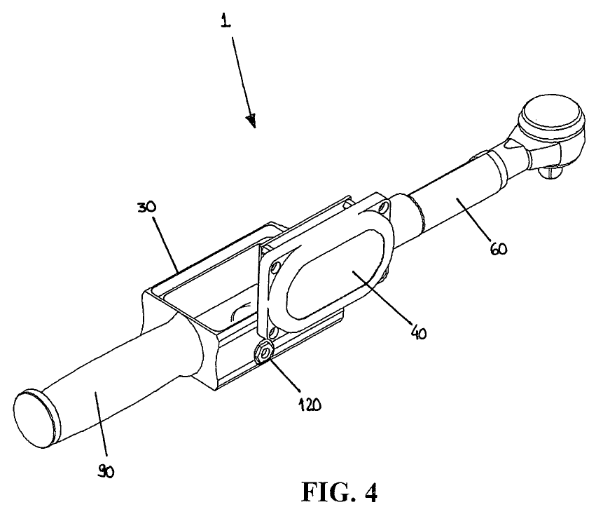

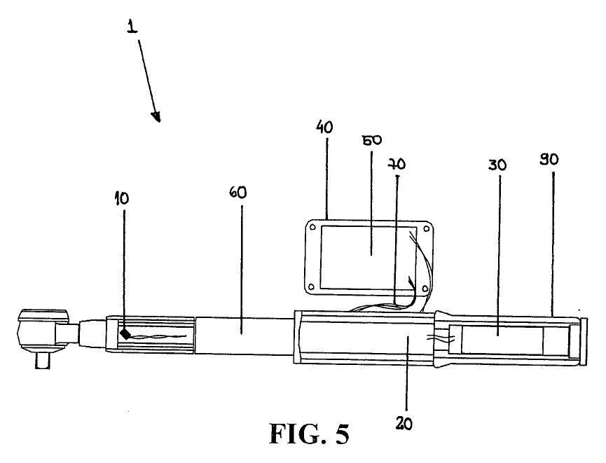

As can be seen from FIGS. 1 through 5, the measure acquisition assembly has been coupled to a key 1, in order to check the torque applied to screws in an assembly line, for example. The key 1 has a handle 90 for receiving power supply 20, which will provide the present invention measure acquisition assembly with power.

Handle 90 is received by the assembly comprised of casing 30, cover 40 and electronic card 50 coupled to said cover 40. The wires 70 go through hole 100, 110 and are responsible by the connection of electronic card 50 with power supply 20 and transducer 10, which is located in body 60 of key 1, respectively. Optionally, such connections mentioned above may be made without wires 70.

It is worth noting that, in this illustrated embodiment, the transducer is located in body 60 of key 1. However, this transducer may be positioned in another location, depending on the tool the measure acquisition assembly is coupled to.

The assembly further may include a hole 80 through which wires 70 also pass, connecting electronic card 50 to outer supply 120. This outer supply serves to make possible recharging power supply 20.

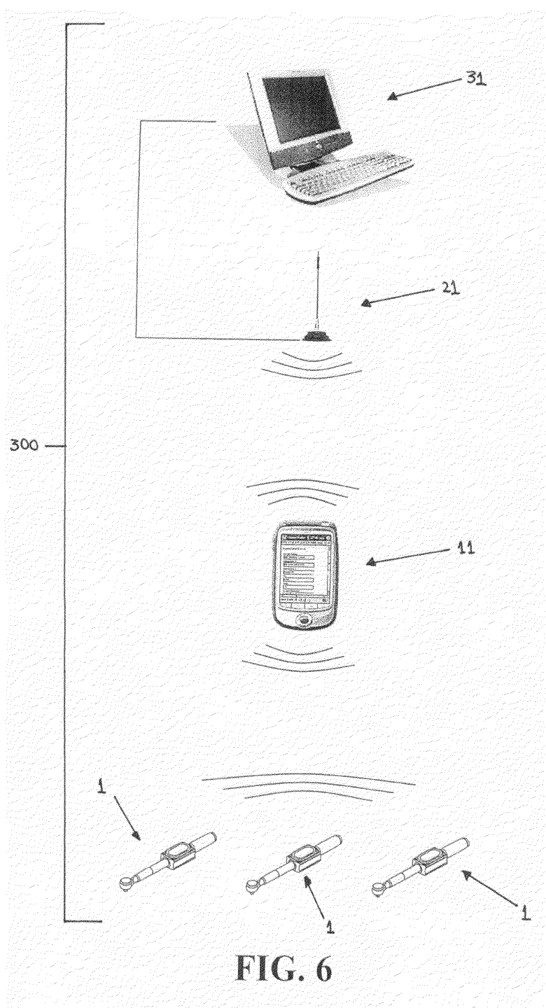

In FIG. 6, one can see how keys 1 communicate with the rest of the assembly. The measurements are effected by key 1, and the data from the measurements are sent to receiver means 11, such as personal data assistant (PDA) or any other receiver means commonly available on the market. The measured data transmission is done by radiofrequency (RF), which gives the system more robustness and stability, avoiding possible errors caused by external interference. In addition, the use of RF transmission speeds up the data transmission between key 1 and receiver means 11 and makes possible to manage a number of radio units operating in the same area. Such a transmission may be, for example, via Bluetooth or Wi-Fi.

After receiving at receiver means 21, the user may choose to send the data collected by the means to base station 31, again, wirelessly, by radiofrequency. At this step, there will be an antenna 21 interfacing the data transmission between receiver means 11 and base station 31.

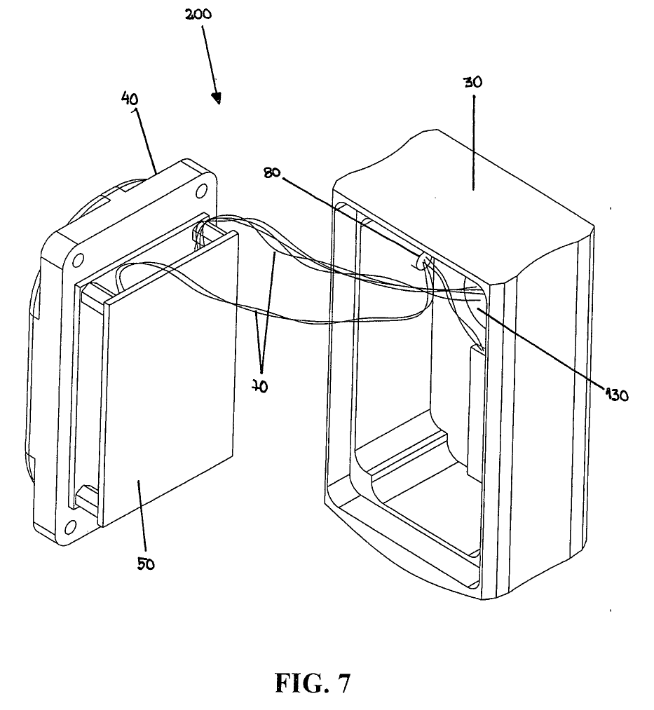

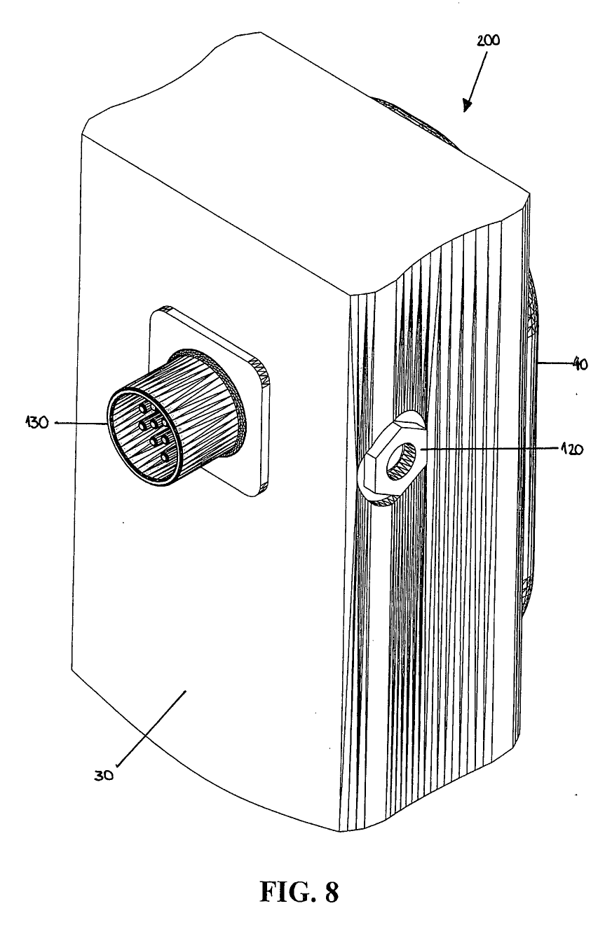

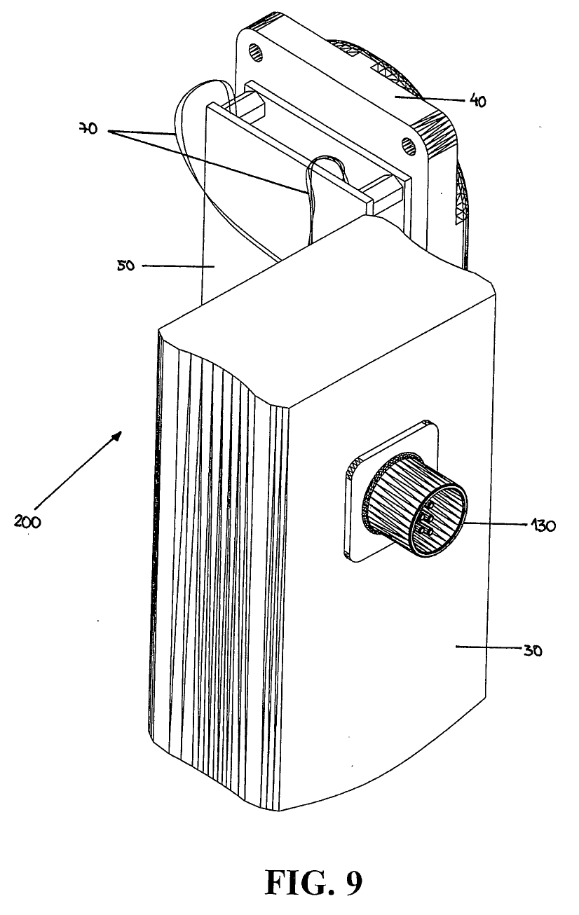

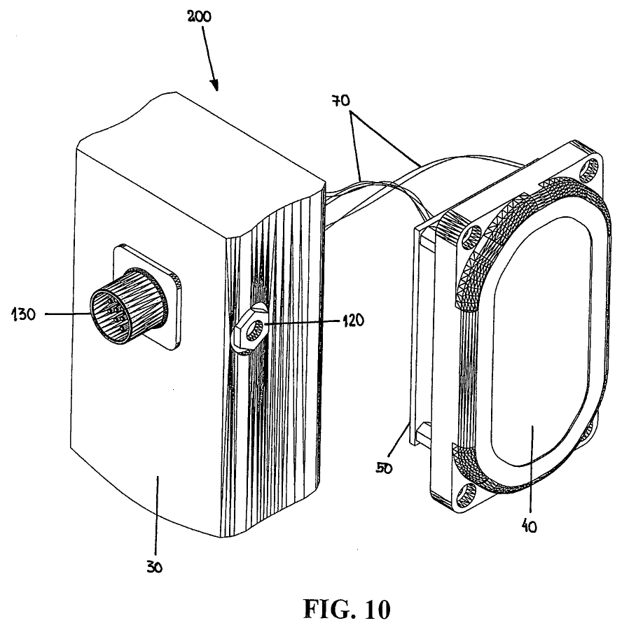

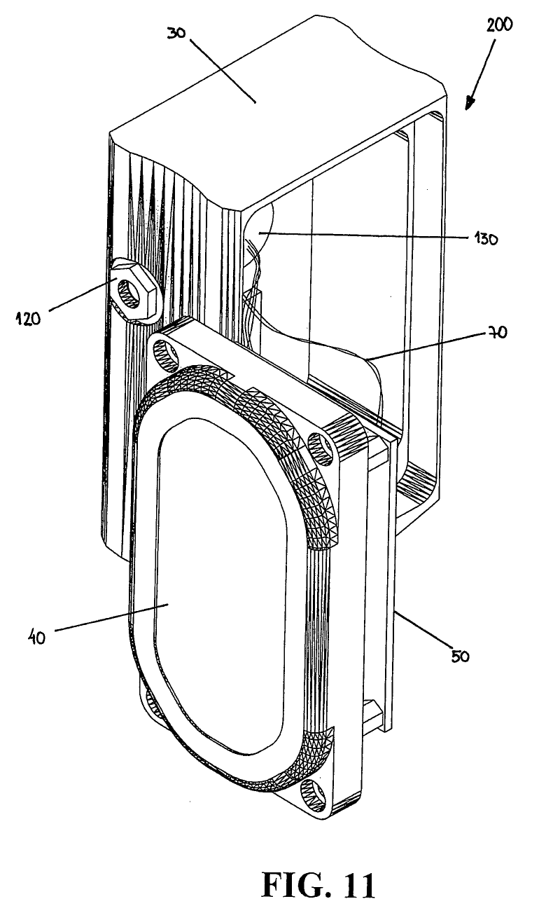

In FIGS. 7 through 11, there is shown the present invention measure acquisition assembly 200, isolated, without being coupled to any special key. As previous illustrated, assembly 200 has a casing 30 which is enclosed by a cover 40. Internally to the cover, electronic card 50 is coupled, being lodged inside casing 30. Electronic card 50 is responsible for transforming the measured values into digital values. These values are later transmitted to transducer 10, which in turn send the values to receiver means 11, which is responsible for displaying the statistics and results relative to the measurement.

In this case, coupled to the casing 30 rear portion is connector 130, serving to connect electronic card 50 to a rotating transducer. Connector 130 is utilized depending on the tool the measure acquisition assembly 200 is coupled to, providing for more flexibility in the use of assembly 200.

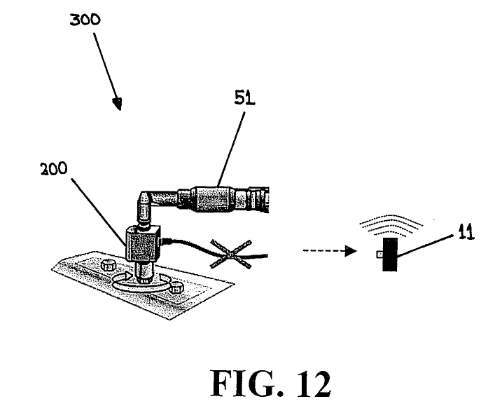

FIG. 12 illustrates the operation of the present invention measure acquisition system 300, comprised of acquisition assembly 200 coupled to another key 51 for measuring data when effecting the tightening of a screw on a predetermined surface.

The data relating to the screw tightening are then processed and sent wirelessly to receiver means 11.

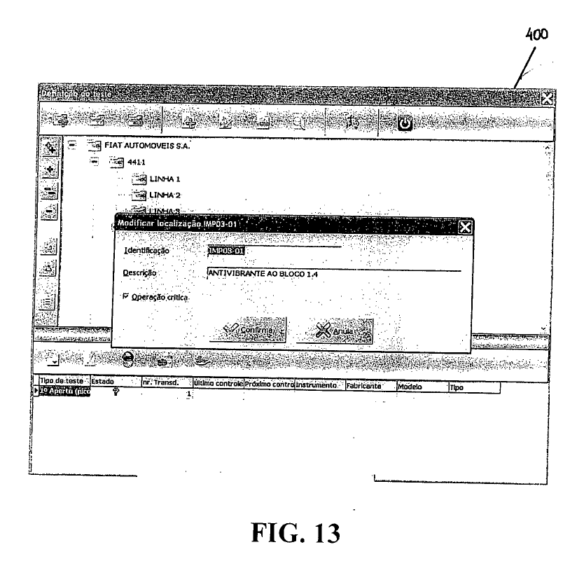

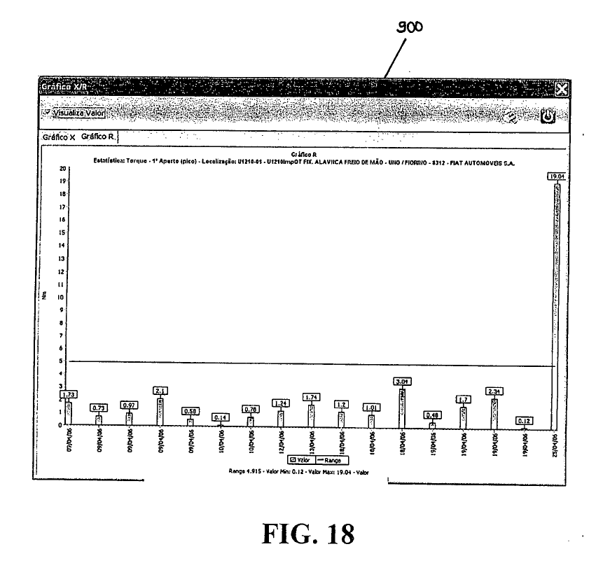

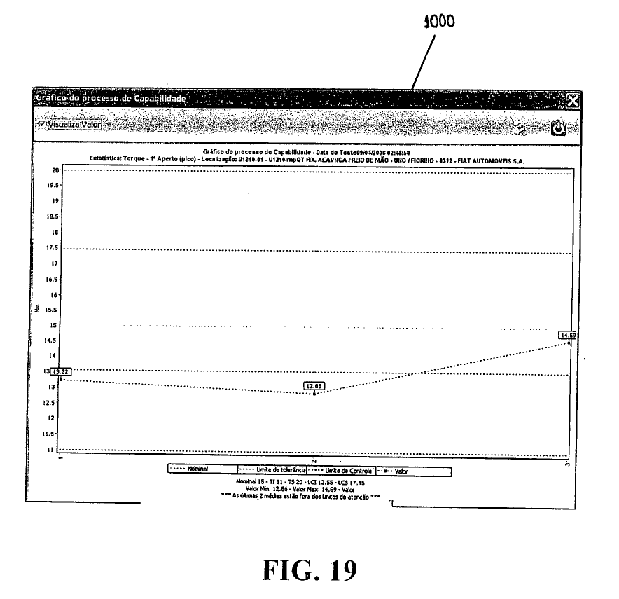

FIGS. 13 through 19 illustrate displays of the software resident both in receiver means 11 and in base station 31. For example, in receiver means 11, information can be displayed such as the torque values as applied and estimated (point to point), as well as whether the same fall into pre-set patterns, apart from charts of the torque values as well as the measurements of the torque across time.

In FIG. 13, display 400 shows parameters being determined and identified according to the test type to be performed.

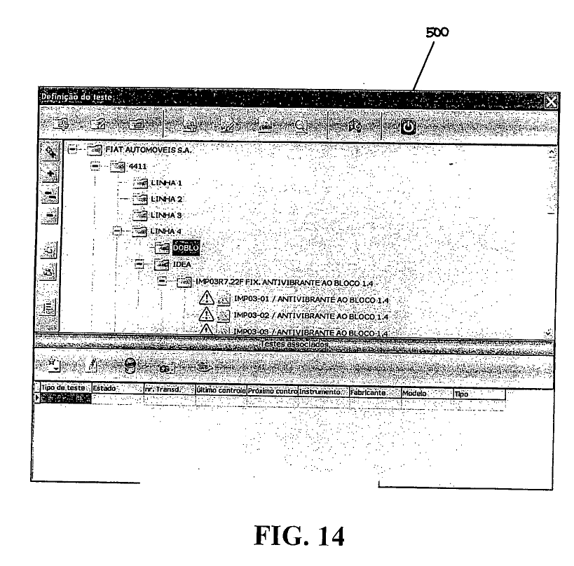

In FIG. 14, in turn, display 500 is shown displaying the definition of the tests to be performed during the use of the present invention measure acquisition system 300.

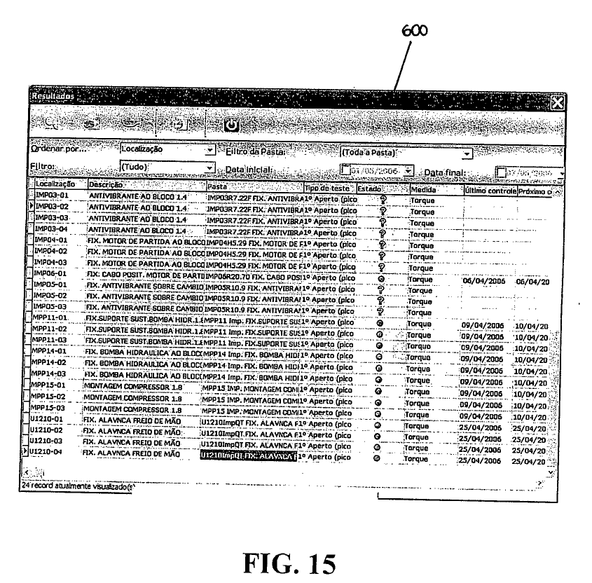

FIG. 15 shows display 600 displaying the results obtained from the measurement performed by system 300, where a listing is presented of all the parameters that have been checked during said measurement.

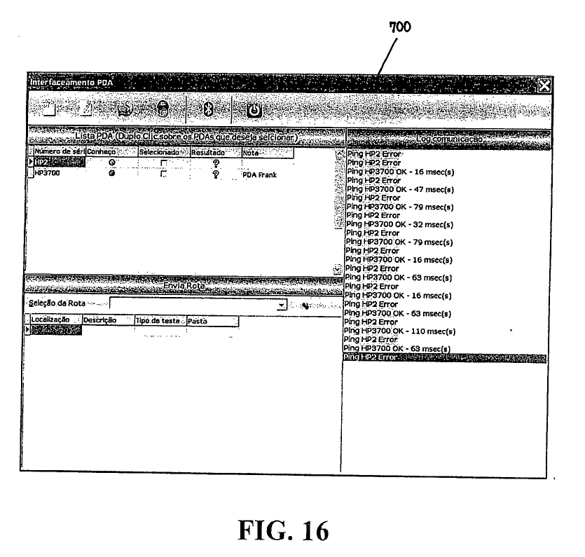

In relation to FIG. 16, display 700 illustrates the software located in base station 31, which is responsible for managing the results from the different receiver means 11. In this display, the user can browse through different receiver means 11 that have been utilized in storing data measured when utilizing measure acquisition system 300.

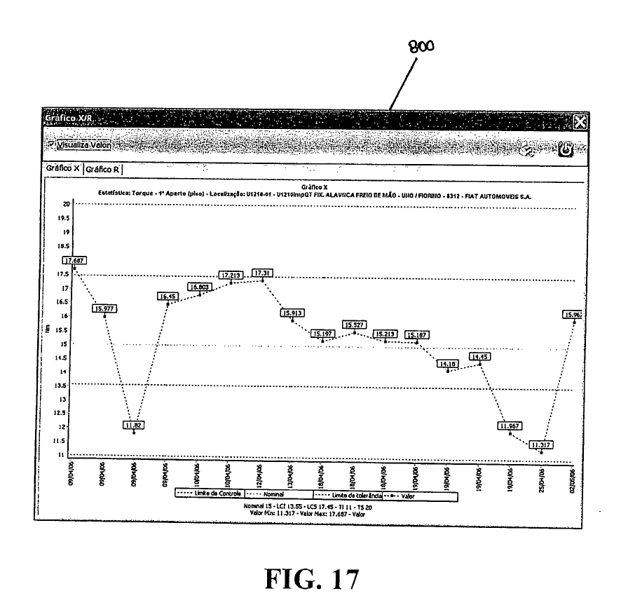

FIGS. 17 through 19 illustrate displays 800, 900, 1000 where the results obtained from the measurement can be analyzed in statistical form, by means of various charts.

Although the above description relates to a preferred embodiment, those skilled in the art should understand that the present invention is not limited to the details of the above teachings.

It should be noted that variations, modifications and changes in the invention herein described are possible to those skilled in the art, without departing from the spirit and scope of the present invention or equivalents thereof, as encompassed by the appended claims and their equivalents.

1. A measure acquisition system, wherein:
a measure acquisition assembly comprising an casing being enclosed by a cover, an electronic card coupled to said cover;
a power supply supplying power to said electronic card;
a transducer connected to said electronic card of the measure acquisition assembly; and
a receiver means that communicates with the measure acquisition assembly by means of radiofrequency.

2. The measure acquisition system, according to claim 1, wherein the measure acquisition assembly comprises a hole in the casing inner portion, connecting the power supply to an outer supply.

3. The measure acquisition system, according to claim 1, wherein the data acquisition assembly comprises holes utilized for coupling the assembly to a tool.

4. The measure acquisition system, according to claim 1, wherein the data acquisition assembly has a connector.

5. The measure acquisition system, according to claim 1, wherein:
an antenna that receives information from the receiver means and transfers the same to a base station.
